(19) United States
(12) Patent Application Publication
(10) Pub. No.: US 2017/0340048 A1
(43) Pub. Date: Nov. 30, 2017

(54) ILLUMINATING FOOTWEAR ASSEMBLY

(71) Applicant: Benjamin F. Goings, Las Vegas, NV (US)

(72) Inventor: Benjamin F. Goings, Las Vegas, NV (US)

(21) Appl. No.: 15/357,704

(22) Filed: Nov. 21, 2016

Related U.S. Application Data
(60) Provisional application No. 62/392,358, filed on May 31, 2016.

(51) Int. Cl. A43B 3/00; F21V 23/02; A43B 1/00; A43B 5/00; F21V 33/00; F21V 5/04; F21S 9/02; A43C 1/00; H05B 37/02; H02J 7/00; F21W 111/10; F21Y 2115/10

(52) U.S. Cl. CPC A43B 3/001; H05B 37/0272; F21V 23/023; A43B 1/0072; A43B 5/002; H02J 7/0052; H02J 7/0042; F21V 33/0008; F21V 5/04; F21S 9/02; A43C 1/00; F21Y 2115/10; F21W 2111/10; H02J 2007/0062

(57) ABSTRACT

An illuminating footwear assembly directs a beam of light from the toe and heel portions of a shoe while being donned by a shoe wearer. The assembly provides a pair of shoes that include a sole portion, an upper portion, a toe portion, and a heel portion. A padding portion inside the cavity segregates the foot from the electrical components. A pair of forward and a pair of rearward illumination portions align to the toe and heel of the shoes, respectively. The illumination portion includes a series of light emitting diodes that are disposed in a spaced-apart relationship. The illumination portions are remotely controlled by the shoe wearer through a transmitter portion that emits a signal to a receiver portion integrated into the shoes. A charging cord attaches between an external power source and a recharging port in the shoe to charge the power source.

### CROSS-REFERENCE TO RELATED APPLICATIONS

The present Utility patent application claims priority benefit of the U.S. provisional application for patent Ser. No. 62/392,358 entitled “SHOE LIGHT” filed on 31 May 2016 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to an illuminating footwear assembly that provides a pair of shoes for walking that integrate a forward and rearward illumination portion aligned to the toe and heel of the shoes, respectively, to project light beams far enough, and with enough brilliance to permit advance warning and view when walking in the dark; whereby the illumination portions are remotely controlled by the shoe wearer and easily recharged.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that footwear refers to garments worn on the feet, which originally serves the purpose of protection against adversities of the environment, usually regarding ground textures and temperature. Footwear in the manner of shoes therefore primarily serves the purpose to ease locomotion and prevent injuries.

Generally, hiking boots are footwear specifically designed for protecting the feet and ankles during outdoor walking activities such as hiking. They are one of the most important items of hiking gear, since their quality and durability can determine a hiker's ability to walk long distances without injury. Hiking boots are constructed to provide comfort for walking considerable distance over rough terrain.

Typically for walking, or even riding a bicycle, at night or in dark areas, a focused headlamp or head light is used. The headlight projects a light beam far enough, with enough brilliance to permit advance warning and view to avoid otherwise unavoidable accidents.

A transmitter is an electronic device which, with the aid of an antenna, produces radio waves, or signals. The transmitter itself generates a radio frequency alternating current, which is applied to the antenna. When excited by this alternating current, the antenna radiates the signal to actuate an event at a remote receiver. Transmitters may be used to remotely turn on and off lights.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a perspective view of an exemplary illuminating footwear assembly being donned and operated by a wearer, in accordance with an embodiment of the present invention;

FIG. 2 illustrates a perspective view of an illuminating footwear assembly, including a pair of shoes integrated with a pair of forward illumination portions and a pair of rearward illumination portion, a transmitter portion, and a charging portion, in accordance with an embodiment of the present invention;

FIG. 3 illustrates a close up view of an exemplary toe portion of a shoe with a forward illumination portion powered off, in accordance with an embodiment of the present invention;

FIG. 4 illustrates a perspective view of an exemplary heel portion of a shoe with a pair of rearward illumination portions powered on and illuminating, in accordance with an embodiment of the present invention;

FIG. 5 illustrates a sectioned view of a shoe, illustrating the wiring, charge port, and a case for a power portion and a receiver portion, secured underneath at least one padding portion, in accordance with an embodiment of the present invention;

FIGS. 6A and 6B illustrate close up views an exemplary charging port and a gate, where in FIG. 6A the gate is in an open position, and in FIG. 6B the gate is in a closed position, in accordance with an embodiment of the present invention; and

FIG. 7 illustrates a close up view of a charging cord operatively connected to a charging port in the heel portion of a shoe, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rocklatex Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### Terminology

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. §112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

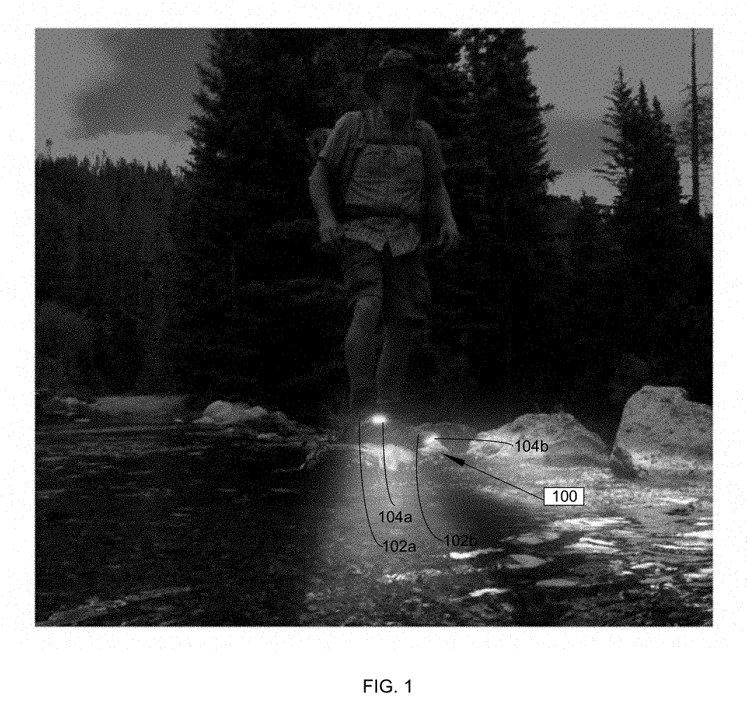

There are various types of footwear and lighting devices that may be provided by preferred embodiments of the present invention. FIG. 1 illustrates a perspective view of an exemplary illuminating footwear assembly 100 directing a beam of light while being donned by a shoe wearer 106. The illuminating footwear assembly may provide a pair of shoes for walking that integrate a forward and rearward illumination portion aligned to the toe and heel of the shoes, respectively, to project light beams far enough, and with enough brilliance to permit advance warning and view when walking in the dark; whereby the illumination portions are remotely controlled by the shoe wearer and easily recharged.

In some embodiments, the illuminating footwear assembly may include a pair of shoes 102a, 102b, as may be used for walking, running, hiking, sporting, or climbing. The shoes may include a sole portion that engages a ground surface, an upper portion that forms a cavity to receive the foot, a toe portion that aligns with the toes, and a heel portion that aligns with the heels. A padding portion inside the cavity may serve to provide comfort to the wearer and also to segregate the foot from the electrical components of the assembly.

In some embodiments, the shoes may have integrated within, a pair of forward illumination portions 104a, 104b and a pair of rearward illumination portions aligned to the toe and heel of the shoes, respectively. Each shoe may have its own identical set of forward and rearward illumination portion. In one embodiment, at least one toe opening in the toe portion enables snug fitting of the forward illumination portions. In another embodiment, at least one heel opening extending across the heel portion may enable snug fitting of the rearward illumination portions.

The illumination portions may be configured to project light beams far enough, and with enough brilliance to permit advance warning and view when walking in the dark. The forward and rearward illumination portions may be operated together or independently. The illumination portions may direct a steady beam of light. Those skilled in the art will recognize that a steady beam of light is most effective for guiding and enabling viewing. In one embodiments, the illumination portion may include a series of light emitting diodes that are disposed in a spaced-apart relationship. Those skilled in the art will recognize that the forward illumination portions may guide the wearer in the dark, while the rearward illumination portions may enhance viewing of the wearer from behind.

Operation of the illumination portions may be remotely controlled by the shoe wearer 106. The wearer may have a transmitter portion that emits a signal to a receiver portion integrated into the pair of shoes. Upon receiving the signal from the transmitter portion, the receiver portion actuates the illumination portions to emit a steady beam of light. The assembly may further include a detachable charging cord that extends from an external power source to a recharging port in the shoe to charge the power source in the shoes.

Thus, the footwear illumination assembly may provide advantages, including, without limitation: allowing the wearer to see the terrain on which they tread before actually reaching that terrain; eliminating the need for wearers to have other means of illumination, such as flashlights; allowing users to benefit from lighting without need to carry other means of illumination, such as flashlights; allowing the wearer to benefit from lighting while keeping their hands free; allowing the wearer to benefit from lighting while they carry other items of need; projecting lighting where illumination is needed most in many environments; illuminating outdoor terrain in environments such as but not limited to hiking trails, forests, sidewalks, streets, rural areas and many other unlit places; and generally improving the safety of the wearer.

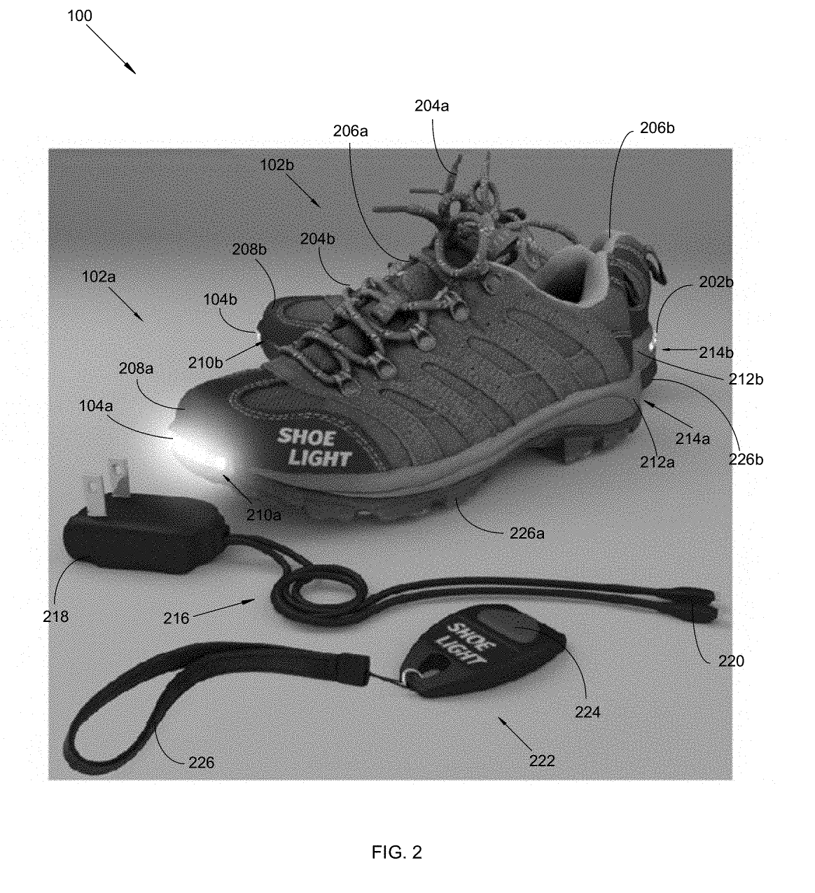

FIG. 2 illustrates a perspective view of an illuminating footwear assembly, including a pair of shoes integrated with a pair of forward illumination portions and a pair of rearward illumination portions 202b, a transmitter portion, and a charging portion. The illumination portions may include a series of ultra-high powered light emitting diodes (LEDs) of 12-volt format. In one embodiment, five LEDs are used in a spaced-apart relationship, and connected through wiring. The illumination portions may be white or have different alternating colors. Though for visibility, a white color may be more effective.

In one aspect, the assembly may utilize any pair of shoes or footwear for integration of the illumination portions. The shoes may include a sole portion 226a, 226b that provides traction. The sole portion may be thicker for hiking shoes. The shoes may further include an upper portion 206a, 206b that substantially cover the feet. The upper portion for a hiking shoe may be more durable and allow air to pass through for breathability. Further, a fastening portion 204a, 204b, such as shoe strings may be used to help secure the shoes to the feet of the wearer.

The shoes may further include a toe portion 208a, 208b that aligns with the toes. The toe portion may include a region of the shoes that extends in an arc across and above the toes of the wearer. The toe portion may include at least one toe opening 210. The toe opening may be elongated to receive a series of light emitting diodes. The shoes may further include a heel portion 212a, 212b that aligns with the heels. The heel portion may include a region of the shoes that extends in an arc across and above the heels of the wearer. The heel portion may include at least one heel opening 214a, 214b. The heel openings may be elongated to receive a series of light emitting diodes, or rectangular, so as to enable access to a charging port, described below.

The assembly may power the illumination portions with a power source. The power source may include, without limitation, a nickel-metal hydride battery, a nickel cadmium (NiCd) battery, a lithium ion (Li-ion) battery, a coin battery, a rechargeable battery, and a renewable energy source. In some embodiments, the power source may also include disposable batteries. Further, a door to the case hosting the power source may be positioned at various strategic locations in the shoe.

An integrated charging system allows the power source to be quickly charged by docking with an external power source. In some embodiments, a charging cord 216 may carry electricity from the external power source to a recharging port in the shoe. The charging cord may include a dock end 218 that engages the external power source, and a shoe end 220 that engages the recharging port in the shoe. The recharging port may be accessible through the at least one heel opening.

In yet another unique aspect of the disclosure, the assembly may allow the wearer to remotely control operation of the light beams emitted by the illumination portions. A transmitter portion 222 may transmit a radio frequency towards a receiver portion in the shoes to actuate the illumination portions. In one embodiment, the transmitter portion may include a hand-held switch 224 that the user depresses to power on and power off the illumination portions; and thereby the light beams emitting form the toe portion or the heel portion, or both. The transmitter portion may also include an FOB-style keychain. In one embodiment, a handle 226 may be used to enable manipulation of the transmitter portion, or tether the transmitter portion to the wearer. The handle may include a wrist strap.

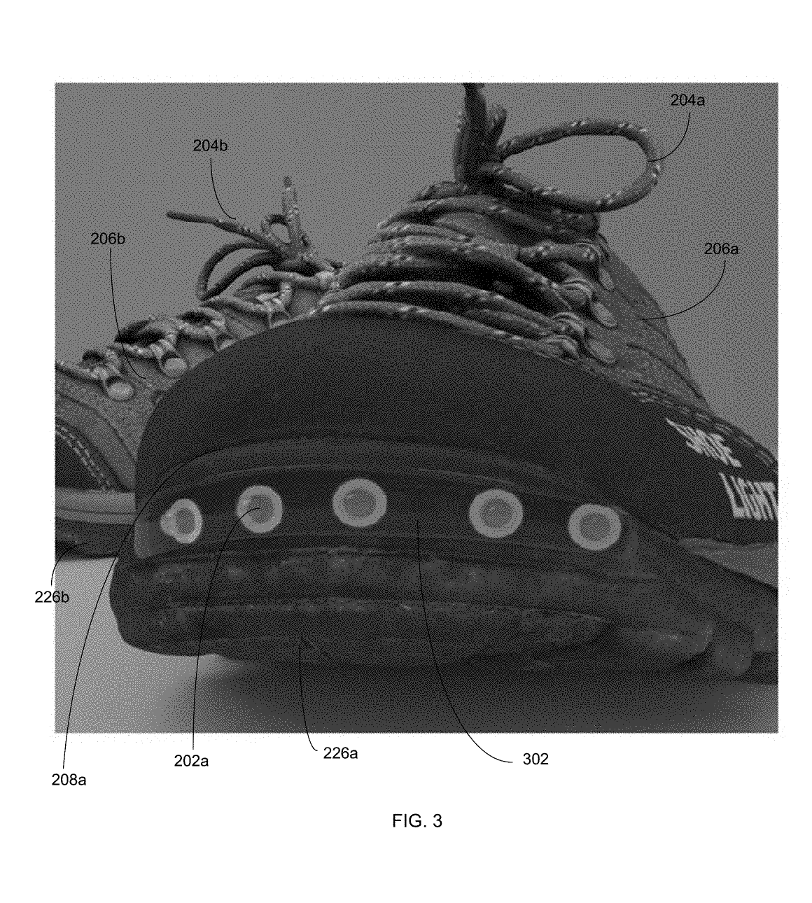

FIG. 3 illustrates a close up view of an exemplary toe portion of a shoe with a forward illumination portion powered off. In one aspect, the illumination portions may include a series of light emitting diodes (LEDs) disposed in a spaced-apart relationship. The forward illumination portions are shown in this disposition in FIG. 3. However, since the illumination portions may be integrated into both the toe and heel portions, physical contact with the ground surface and other objects is likely, and especially with hiking shoes. Thus, the assembly may further comprise a protective lens portion 302 that covers the toe and heel openings, and thereby covers the respective illumination portions. The lens portion is sufficiently durable, so as to deflect physical impact, moisture, and debris from the LEDs. The lens portion may include a clear, durable plastic material. Though in some embodiments, the lens portion may be opaque or colored or both.

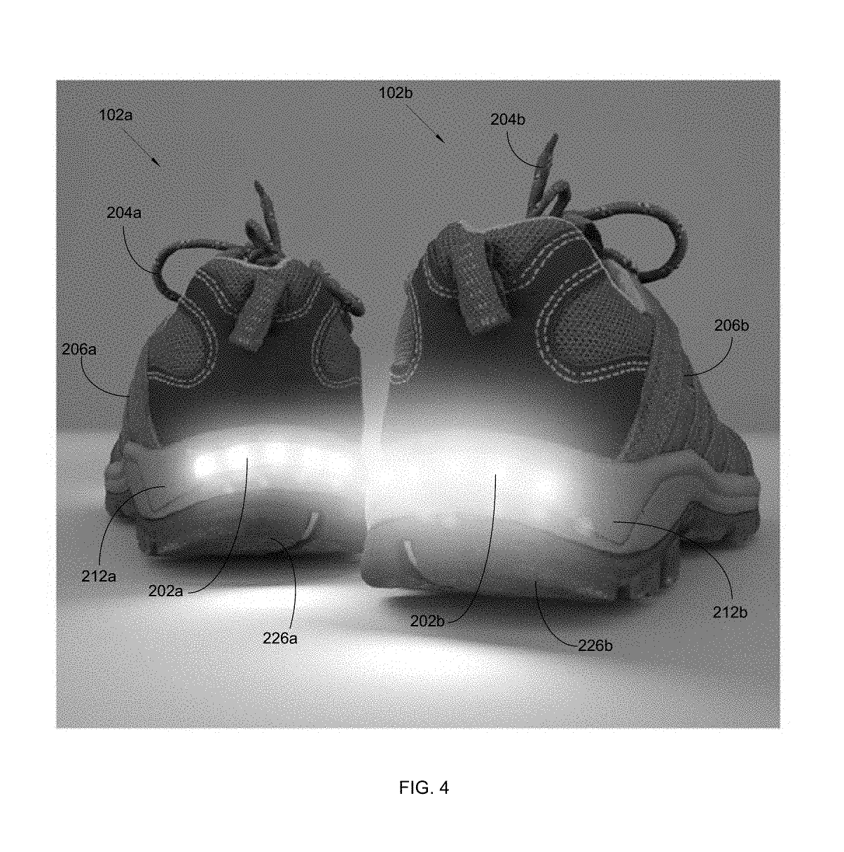

FIG. 4 illustrates a perspective view of an exemplary heel portion of a shoe with a pair of rearward illumination portions 202a, 202b powered on and emitting a steady beam of light. In one aspect, the rearward illumination portions are shown to be emitting light beams, even when the lens portion is affixed over the heel opening and the illumination portions. The lens may be configured to minimize scattering the light, since the lens portion primarily serves as a protective barrier.

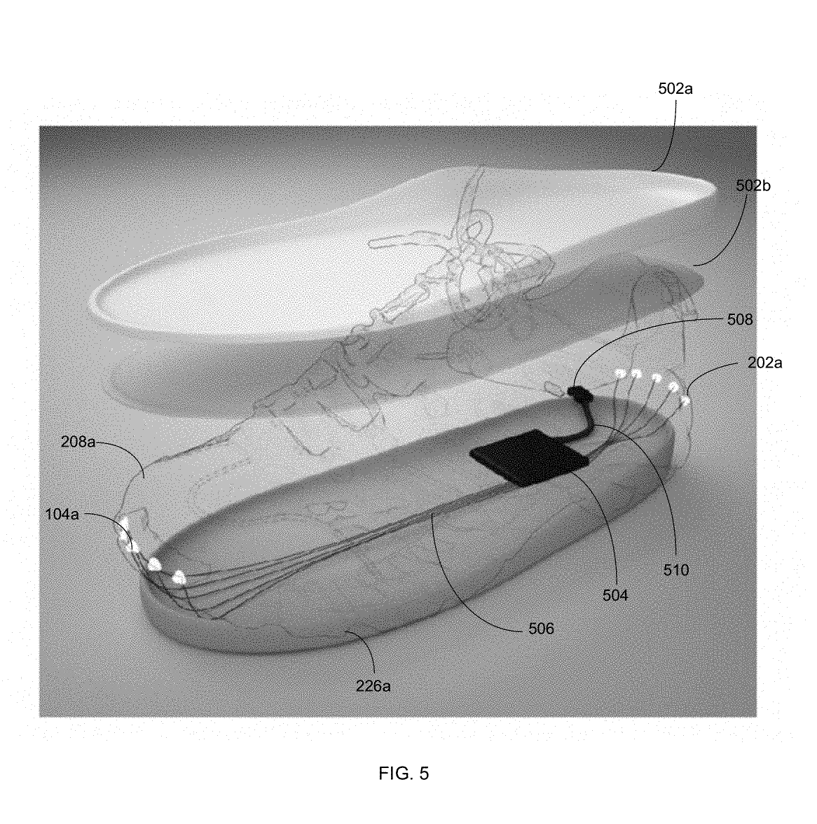

FIG. 5 illustrates a sectioned view of a shoe, illustrating the wiring, charge port, and a case for a power portion and a receiver portion, secured underneath at least one padding portion. In one aspect, the charging system of the assembly may allow the wearer to dock the shoes anywhere a compatible external power source is available. This may be especially useful when camping. As discussed above, the assembly may power the illumination portions with a power source that is integrated into the shoe and protected by a case 504. The case may also serve the dual purpose of protecting the receiver portion that communicates with the transmitter portion for actuating the illumination portions.

In some embodiments, a charging cord may carry electricity from the external power source to a recharging port 508 in the shoe. The recharging port may include a USB port. From the recharging port, a cable 510 in the cavity of the upper portion of the shoe may carry the electricity to the power source in the case. A plurality of wiring 506 may then distribute the electricity in controlled manner to the forward and rearward illumination portions. In this manner, the power source may be quickly charged by docking with an external power source.

Further, the shoe may also include a padding portion 502a, 502b that overlays the case, the wiring, and the cable, so as to provide protection for these components and comfort for the wearer. The padding portion may include a cushioned interior shoe liner and an interior upper sole.

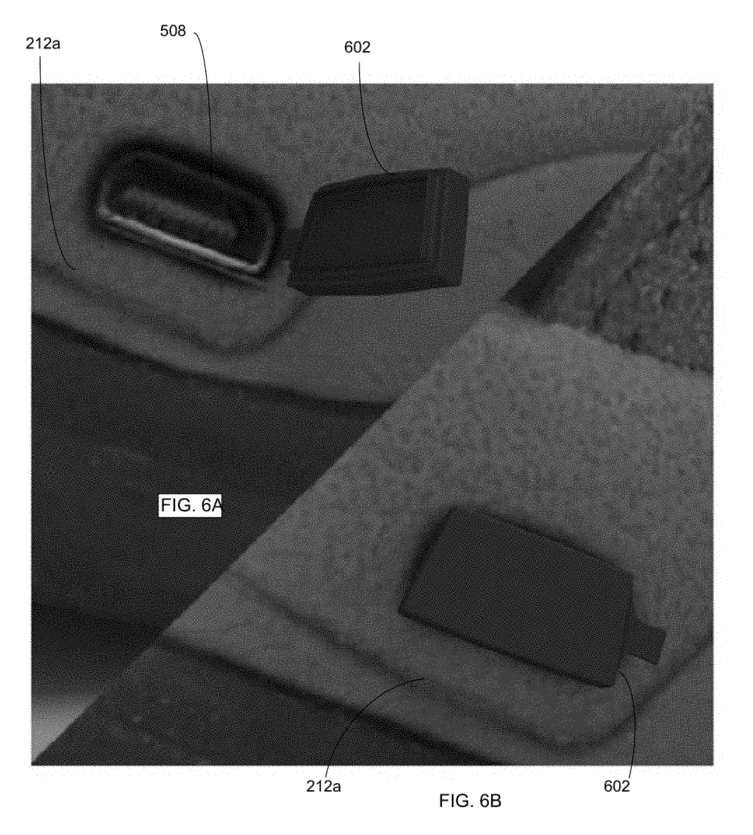

FIGS. 6A and 6B illustrate close up views an exemplary charging port and a gate, where in FIG. 6A the gate is in an open position, and in FIG. 6B the gate is in a closed position. In one aspect, the shoes, and especially hiking shoes may be susceptible to moisture and debris entering the heel opening, and thereby the recharging port. Thus, a gate portion 602 may be used to selectively cover the recharging port for protection against debris and access for recharging.

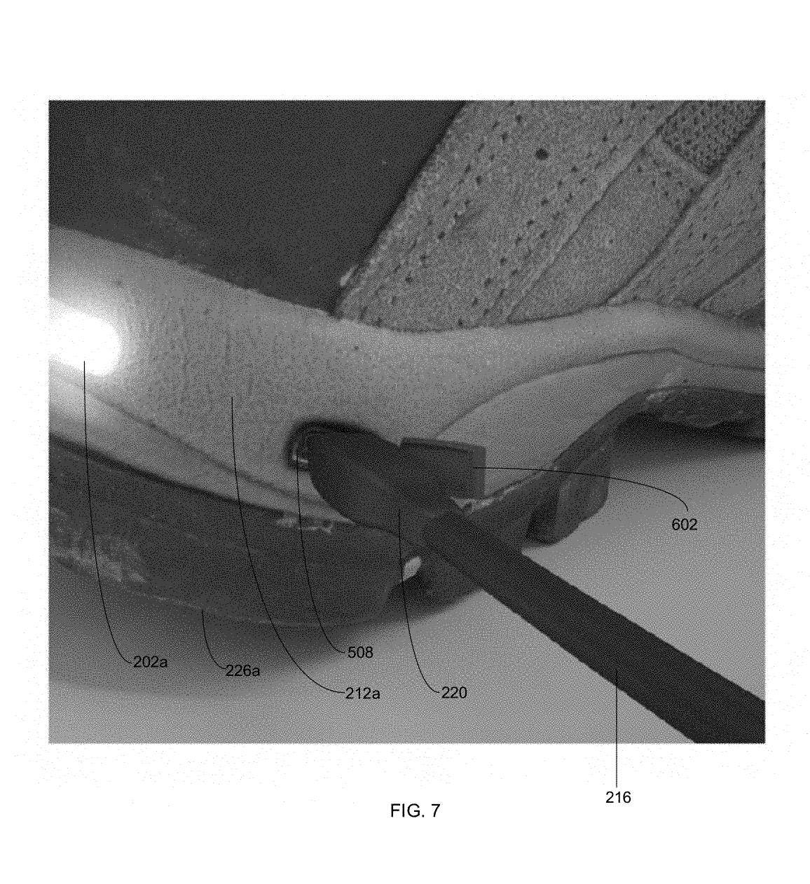

FIG. 7 illustrates a close up view of a charging cord operatively connected to a charging port in the heel portion of a shoe. In one aspect, the gate may be moved to an open position to enable the shoe end of the charging cord. The gate may be a flexible rubber tab that hingedly joins one end of the heel opening. The gate may fasten to a closed position through a friction fit relationship with the heel opening.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a pair of illuminating shoes according to the present invention will be apparent to those skilled in the art. Various aspects of the invention have been described above by way of illustration, and the specific embodiments disclosed are not intended to limit the invention to the particular forms disclosed. The particular implementation of the pair of illuminating shoes may vary depending upon the particular context or application. By way of example, and not limitation, the shoes having a forward and rearward facing LEDs and being remotely controlled by the wearer; however, similar techniques may instead be applied to any type of garment, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. An assembly comprising:
a pair of shoes, said pair of shoes comprising a sole portion, an upper portion, at least one padding portion, a toe portion, and a heel portion, said toe portion comprising at least one toe opening, said heel portion comprising at least one heel opening;
a pair of forward illumination portions, said pair of forward illumination portions being configured to be received by said at least one toe opening, said pair of forward illumination portions further being configured to emit a beam of light;
a pair of rearward illumination portions, said pair of rearward illumination portions being configured to be received by said at least one heel opening, said pair of rearward illumination portions further being configured to emit said beam of light;
a transmitter portion, said transmitter portion being configured to transmit a signal towards said pair of shoes;
a receiver portion, said receiver portion being disposed between said at least one padding portion and said sole portion of said pair of shoes, said receiver portion further being configured to operatively connect to said pair of forward illumination portions and said pair of rearward illumination portions, said receiver portion further being configured to actuate said pair of forward illumination portions and said pair of rearward illumination portions to emit said beam of light;
a power source, said power source being configured to power said pair of forward illumination portions and said pair of rearward illumination portions;
a recharging port, said recharging port being configured to at least partially extend from said at least one heel opening, or said at least one toe opening, or both, said recharging port further being configured to operatively connect to said power source, said recharging port further being configured to receive electricity for charging said power source; and
a charging cord comprising a dock end and a shoe end, said dock end being configured to operatively join with an external power source, said shoe end being configured to join with said recharging port, whereby said charging cord carries electricity from said external power source to said recharging port for recharging said power source.

2. The assembly of claim 1, in which said pair of shoes comprises hiking boots.

3. The assembly of claim 2, in which said pair of shoes further comprises a fastening portion.

4. The assembly of claim 3, wherein said fastening portion comprises shoestrings or hook and loop fasteners.

5. The assembly of claim 4, wherein said toe portion of said pair of shoes is configured to form an arc across and above the toes.

6. The assembly of claim 5, wherein said heel portion of said pair of shoes is configured to form an arc across and above the heels.

7. The assembly of claim 6, in which said pair of forward illumination portions and said pair of rearward illumination portions comprises 12-volt ultra-high powered light emitting diodes.

8. The assembly of claim 7, wherein said 12-volt ultra-high powered light emitting diodes are disposed in a spaced-apart relationship.

9. The assembly of claim 8, in which said transmitter portion comprises a switch.

10. The assembly of claim 9, in which said transmitter portion comprises a handle.

11. The assembly of claim 10, further including a case, said case being configured to at least partially encapsulate said receiver portion and said power source.

12. The assembly of claim 11, further including a lens portion.

13. The assembly of claim 12, wherein said lens portion comprises an at least partially transparent band of plastic.

14. The assembly of claim 13, wherein said lens portion is configured to at least partially overlay said pair of forward illumination portions and said pair of rearward illumination portions.

15. The assembly of claim 14, in which said power source comprises at least one of the following: a nickel-metal hydride battery, a nickel cadmium battery, a lithium ion battery, a coin battery, a rechargeable battery, and a renewable energy source.

16. The assembly of claim 15, wherein said a shoe end of said charging cord is adapted to mate with a USB port.

17. The assembly of claim 16, further including a gate portion, said gate portion being configured to regulate access to said recharging port.

18. The assembly of claim 17, further including a plurality of wiring and a cable to carry electricity from said recharging port to said power source.

19. An assembly device comprising:
means for donning propulsion means;
means for transmitting a signal towards said propulsion means;
means for actuating illumination from said propulsion means;
means for powering said illumination means; and
means for enabling access to said powering means.

20. An assembly consisting of:
a pair of shoes, said pair of shoes comprising a sole portion, an upper portion, at least one padding portion, a fastening portion, a toe portion, and a heel portion, said toe portion comprising at least one toe opening, said heel portion comprising at least one heel opening;
a pair of forward illumination portions, said pair of forward illumination portions being configured to be received by said at least one toe opening, said pair of forward illumination portions further being configured to emit a beam of light;
a pair of rearward illumination portions, said pair of rearward illumination portions being configured to be received by said at least one heel opening, said pair of rearward illumination portions further being configured to emit said beam of light,
wherein said pair of forward illumination portions and said pair of rearward illumination portions comprises 12-volt ultra-high powered light emitting diodes;
a transmitter portion, said transmitter portion being configured to transmit a signal towards said pair of shoes;
a receiver portion, said receiver portion being disposed between said at least one padding portion and said sole portion of said pair of shoes, said receiver portion further being configured to operatively connect to said pair of forward illumination portions and said pair of rearward illumination portions, said receiver portion further being configured to actuate said pair of forward illumination portions and said pair of rearward illumination portions to emit said beam of light;
a power source, said power source being configured to power said pair of forward illumination portions and said pair of rearward illumination portions;
a recharging port, said recharging port being configured to at least partially extend from said at least one heel opening, or said at least one toe opening, or both, said recharging port further being configured to operatively connect to said power source, said recharging port further being configured to receive electricity for charging said power source;
a lens portion, said lens portion comprising an at least partially transparent band of plastic, said lens portion being configured to at least partially overlay said pair of forward illumination portions and said pair of rearward illumination portions;
a charging cord comprising a dock end and a shoe end, said dock end being configured to operatively join with an external power source, said shoe end being configured to join with said recharging port, whereby said charging cord carries electricity from said external power source to said recharging port for recharging said power source; and
a case, said case being configured to at least partially encapsulate said receiver portion and said power source.
